(19) United States
(12) Patent Application Publication
(10) Pub. No.: US 2018/0089439 A1
(43) Pub. Date: Mar. 29, 2018

(54) DETECTION OF IPC-BASED MOBILE VULNERABILITIES DUE TO INSUFFICIENT CALLER PERMISSIONS

(71) Applicant: INTERNATIONAL BUSINESS MACHINES CORPORATION, ARMONK, NY (US)

(72) Inventors: Roee Hay, Haifa (IL); Marco Pistoia, Amawalk, NY (US); Shahar Sperling, Tel-Mond (IL); Omer Tripp, Campbell, CA (US)

(21) Appl. No.: 15/279,880

(22) Filed: Sep. 29, 2016

(51) Int. Cl. G06F 21/57; G06F 21/62; G06F 9/54

(52) U.S. Cl. CPC G06F 21/577; H04W 24/08; G06F 9/546; G06F 21/629

(57) ABSTRACT

Provided herein is a system, method, and computer program product for determining vulnerabilities in a target application of a mobile device. Determining vulnerabilities includes analyzing an inter-application communication interface of the target application to construct a list of incoming messages/Determining vulnerabilities also includes analyzing how the target application responds to message types of the incoming messages utilizing the list to associate caller permissions with the message types/In turn, determining the vulnerabilities of the target application can be based on discrepancies between the caller permissions and the message types.

### BACKGROUND

The disclosure relates generally to detection of inter-application communication (IPC) based mobile vulnerabilities due to insufficient caller permissions and, more particularly, to checking whether there is a difference in permissions specific to an application programmable interface (API) and permissions required to interact with a target application.

Mobile technologies and mobile applications are rich and diverse, along with being in a constant state of evolution. With this constant state of evolution, security defects for mobile technologies and mobile applications are also present. A security defect of mobile applications relates to inter-application communication (IPC) channels. IPC channels can be used via an application (target application) residing on the same device without requiring any form of user interaction.

### SUMMARY

According to one embodiment, a method for determining vulnerabilities in a target application of a mobile device is provided herein. Determining vulnerabilities includes analyzing an inter-application communication interface of the target application to construct a list of incoming messages. Determining vulnerabilities also includes analyzing how the target application responds to message types of the incoming messages utilizing the list to associate caller permissions with the message types. In turn, the determining of the vulnerabilities of the target application can be based on discrepancies between the caller permissions and the message types.

According to another embodiment, a computer program product is provided herein. The computer program product includes a computer readable storage medium having program instructions for determining vulnerabilities in a target application of a mobile device embodied therewith. The program instructions are executable by a processor to cause the processor to perform an analysis of analyzing an inter-application communication interface of the target application to construct a list of incoming messages. The program instructions are also executable by a processor to cause the processor to perform an analysis of how the target application responds to message types of the incoming messages utilizing the list to associate caller permissions with the message types. In turn, the determining of the vulnerabilities of the target application can be based on discrepancies between the caller permissions and the message types.

According to another embodiment, a system is provided herein. The system includes a processor and a memory storing program instructions for determining vulnerabilities in a target application of a mobile device thereon. The program instructions are executable by a processor to cause the system to perform an analysis of an inter-application communication interface of the target application to construct a list of incoming messages. The program instructions are also executable by the processor to cause the system to perform an analysis of how the target application responds to message types of the incoming messages utilizing the list to associate caller permissions with the message types. In turn, the determining of the vulnerabilities of the target application can be based on discrepancies between the caller permissions and the message types.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 illustrates a process flow of a detection analysis by a detection system in accordance with an embodiment;

FIG. 2 illustrates a process flow of a permission analysis by a detection system in accordance with an embodiment;

FIG. 3 illustrates a process flow of a per-permission behavior modeling by a detection system in accordance with an embodiment; and

FIG. 4 illustrates a processing system in accordance with an embodiment.

### DETAILED DESCRIPTION

Generally, a target application can receive a message via the IPC channels from a malicious application that contains data values crafted for an attack. The malicious application need not be familiar with the target application, as the IPC interface of the application is fully documented in a way that is accessible to other applications (including the malicious application). For example, IPC information can appear in a manifest file of an application, which any other application residing on the same device can read and parse. This provides a malicious application an automated mechanism for attacking arbitrary co-installed applications.

For instance, if the target application is allowed (e.g., by a user installation) to access the internet and has functionality that initiates hypertext transfer protocol (HTTP) communications to a remote website (e.g., or web service) that are triggered in response to incoming messages by caller application, then the target application is vulnerable if permissions are not required from the caller application. In this way, the target application is vulnerable to an IPC attack by the malicious application because of the lack of the permissions. The vulnerability is even more severe if the caller application can influence data values sent as part of the HTTP request.

There is a need for an analysis technique designed to detect security vulnerabilities due to incompatibility between caller permissions and the functionality performed by the target application in response to incoming messages.

Embodiments disclosed herein may include a detection system, method, and/or computer program product (herein detection system) for implementing a detection analysis of vulnerabilities due to an ability by an attacker application to abuse an IPC surface of a target application.

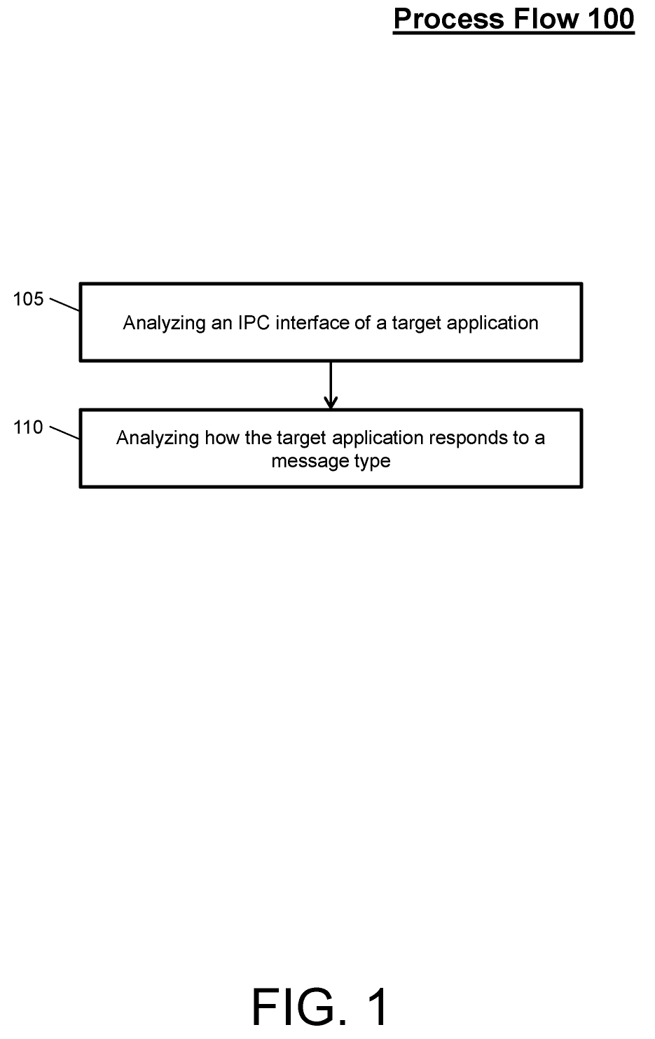

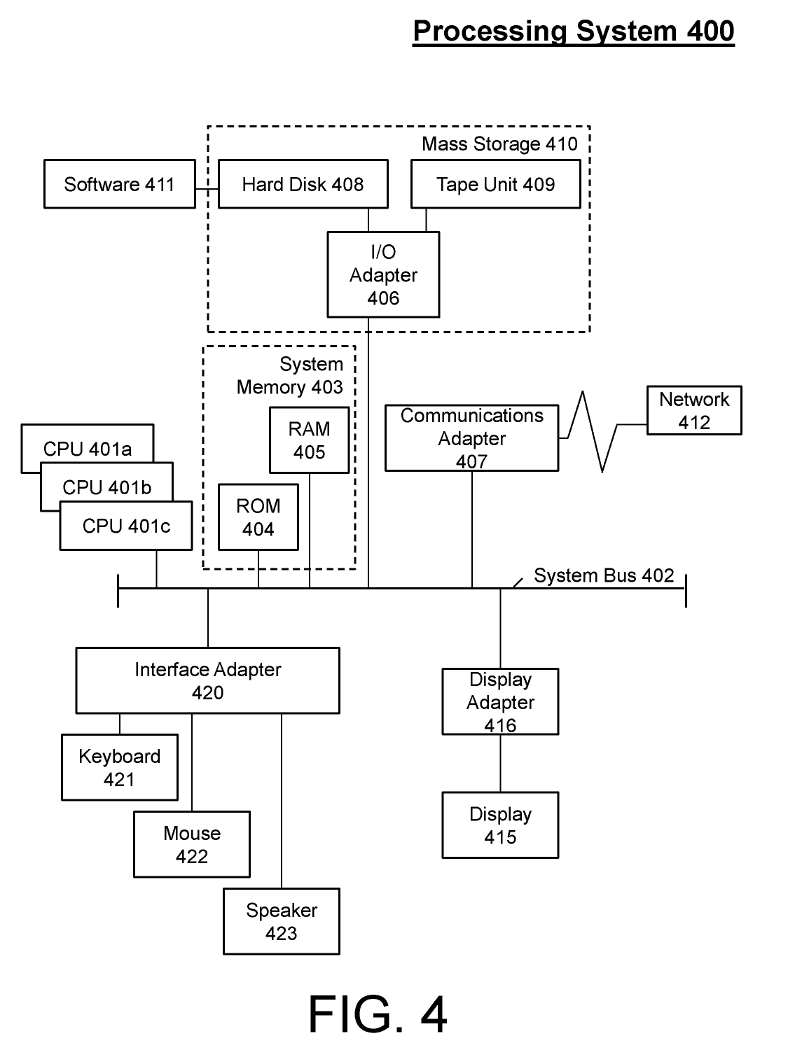

Turning now to FIG. 1, a process flow 100 of a detection analysis by a detection system is generally shown in accordance with an embodiment. The detection system can be hardware, software, or combination thereof installed on or in communication with a mobile device comprising a mobile application under test (i.e., the target application). The mobile device can be a processing system as further described below with respect to FIG. 4, example of which include a smartphone.

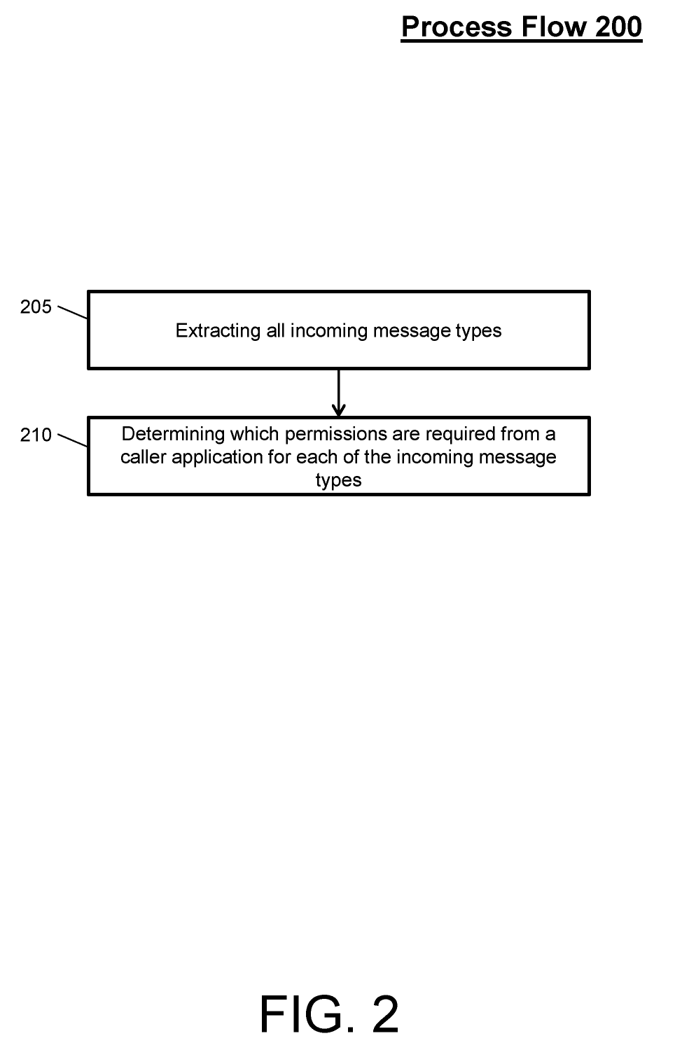

The process flow beings at block 105, where the detection system analyzes an IPC interface of the target application (permission analysis described with respect to FIG. 2). Analyzing the IPC interface of the target application comprises identifying which permissions are required for each type of incoming message by parsing IPC-related resources (e.g., a manifest file of the target application).

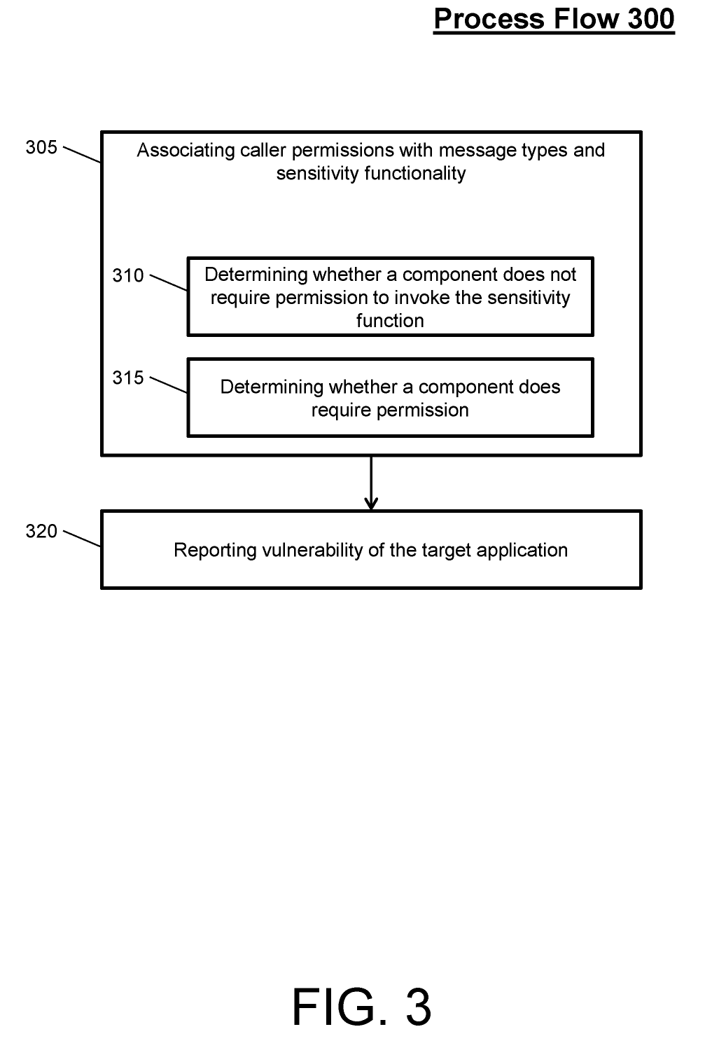

At block 110, the detection system analyzes how the target application responds to a message type (per-permission behavior modeling described with respect to FIG. 3). Analyzing how the target application may respond to the message type comprises analyzing a code of the target application to build a model of how each type of incoming message is analyzed. Note that, for accuracy, the analysis of block 110 can be message sensitive (e.g., in the sense that for each message the analysis would generate a separate model).

Turning now to FIG. 2, a process flow 200 of a permission analysis by a detection system is generally shown in accordance with an embodiment. At block 205, the detection system extracts all incoming message types. The detection system can extract all the incoming message types from the manifest file of the target application. In a non-limiting embodiment, the incoming messages comprise required data. The required data identifies which components of the mobile device that the incoming message should be delivered to. The detection system, in turn, can construct a list of the incoming messages according to this required data (e.g., type of component the incoming message should be delivered to). Note that a set of incoming message types can be finite and statically known within the manifest file.

At block 210, the detection system determines which permissions are required from a caller application for each of these message types. For example, manifest file contains meta-information. Meta-information includes application component information. The application component information details required permission (e.g., permission table) for each one of the components of the mobile device). By parsing the meta-information, the detection system can obtain the permissions per message type and update the list of the incoming messages.

Turning now to FIG. 3, a process flow 300 of a per-permission behavior modeling by a detection system is generally shown in accordance with an embodiment. The per-permission behavior modeling can be a data-flow analysis (or alternatively a slicing analysis) of how the application can respond to a message type. The process flow 300 begins at block 305, where the detection system associates caller permissions with message types and sensitive functionality utilizing the list of the incoming messages. The sensitive functionality defines operations performed by the target application in response to the incoming message types, e.g., sending an SMS message, rebooting the mobile device, utilizing a phone dialer, etc. The sensitive functionality can comprise permissions needed to perform that sensitive functionality.

For instance, the per-permission behavior modeling by the detection system builds safe fix point approximations of sensitive functionalities of the target application on a per-component basis (as shown by the non-limiting example of sub-blocks 310 and 315). The fix point solution approximation permits a direct comparison between the caller permissions and the incoming message types. The safe fix point approximation can be invoked in response to an incoming message. At sub-block 310, the detection system determines whether a component does not require permission to invoke the sensitivity function. At sub-block 315, the detection system determines whether the component does have permissions then then other application must have permissions

At block 320, the detection system reports vulnerabilities. To report vulnerabilities, the detection system can store a vulnerability report (such as a storage data structure) for later use. In a non-limiting embodiment, if discrepancies are detected between the caller permissions and the incoming message types, whereby the performed functionality may extend (either completely or in part) beyond the permissions of a caller application, then vulnerability is reported. In this case, the vulnerability is that a malicious application can guide the target application to perform functionality that is beyond what any application is allowed to perform directly. The detection system can then cause the use of information of the vulnerabilities as a run-time component to block future attacks by the malicious application.

In view of the above, a non-limiting embodiment of the detection system can account for transformations, such as by applying sanitization and validation operations to input data from an incoming message destined for a security-sensitive functionality. In another non-limiting embodiment, the detection system can enable an analysis account for instances where privilege escalation is a desired behavior (e.g., settings application being able to invoke other apps via IPC), such that each entry point can also be assigned a set of privileges that can be escalated.

Referring now to FIG. 4, there is shown an embodiment of a processing system 400 for implementing the teachings herein. In this embodiment, the processing system 400 has one or more central processing units (CPU(s)) 401a, 401b, 401c, etc. (collectively or generically referred to as processor(s) 401). The processors 401, also referred to as processing circuits, are coupled via a system bus 402 to system memory 403 and various other components. The system memory 403 can include a read only memory (ROM) 404 and a random access memory (RAM) 405. The ROM 404 is coupled to system bus 402 and may include a basic input/output system (BIOS), which controls certain basic functions of the processing system 400. The RAM is read-write memory coupled to the system bus 402 for use by the processors 401.

FIG. 4 further depicts an input/output (I/O) adapter 406 and a communications adapter 407 coupled to the system bus 402. The I/O adapter 406 may be a small computer system interface (SCSI) adapter that communicates with a hard disk 408 and/or tape unit (tape storage drive) 409 or any other similar component. The I/O adapter 406, the hard disk 408, and the tape unit 409 are collectively referred to herein as a mass storage 410. A software 411 for execution on the processing system 400 may be stored in the mass storage 410. The mass storage 410 is an example of a tangible storage medium readable by the processors 401, where the software 411 is stored as instructions for execution by the processors 401 to perform a method, such as the process flows of FIGS. 1-3. A communications adapter 407 interconnects the system bus 402 with a network 412, which may be an outside network, enabling the processing system 400 to communicate with other such systems. A display (e.g., screen, a display monitor) 415 is connected to the system bus 402 by a display adapter 416, which may include a graphics controller to improve the performance of graphics intensive applications and a video controller. In one embodiment, the adapters 406, 407, and 416 may be connected to one or more I/O buses that are connected to the system bus 402 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to the system bus 402 via an interface adapter 420 and the display adapter 416. A keyboard 421, a mouse 422, and a speaker 423 can be interconnected to the system bus 402 via the interface adapter 420, which may include, for example, a Super I/O chip integrating multiple device adapters into a single integrated circuit.

Thus, as configured in FIG. 4, the processing system 400 includes processing capability in the form of the processors 401, and, storage capability including the system memory 403 and the mass storage 410, input means such as the keyboard 421 and the mouse 422, and output capability including the speaker 423 and the display 415. In one embodiment, a portion of the system memory 403 and the mass storage 410 collectively store an operating system, such as the z/OS or AIX operating system from IBM Corporation, to coordinate the functions of the various components shown in FIG. 4.

Technical effects and benefits of the detection system comprise checking whether there is a difference in permissions specific to an API and permissions required to interact with a target application. Thus, embodiments described herein are necessarily rooted in a detection system to perform proactive operations to overcome problems specifically arising in the realm of mobile technologies and mobile applications.

Embodiments may include a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments herein.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for determining vulnerabilities in a target application of a mobile device, comprising:
analyzing, by a processor, an inter-application communication interface of the target application to construct a list of incoming messages by:
extracting message types of the incoming messages from a manifest file of the target application, and
determining permissions required from a caller application for the message types of the incoming messages by parsing meta-information of the manifest file;
analyzing, by the processor, how the target application responds to the message types of the incoming messages utilizing the list to associate caller permissions with the message types by:
associating the caller permissions with the message types of the incoming messages and sensitive functionality utilizing the list by building safe fix point approximations of sensitive functionalities of the target application on a per-component basis,
wherein the sensitive functionality define operations performed by the target application in response to the message types,
wherein the fix point solution approximations permit a direct comparison between the caller permissions and the incoming message types, and
determining whether a component requires permission to invoke the sensitive functionality; and
determining, by the processor, the vulnerabilities of the target application based on discrepancies between the caller permissions and the message types; and
utilizing the vulnerabilities of the target application as a run-time component to block attacks by a malicious application,
wherein the incoming messages comprise required data that identifies which components of the mobile device to which a particular incoming message is delivered,
wherein analyzing the inter-application communication interface comprises constructing the list of the incoming messages according to the required data,
wherein the meta-information includes application component information that details a required permission table for each one of the components of the mobile device.

2-8. (canceled)

9. A computer program product, the computer program product comprising a non-transitory computer readable storage medium having program instructions for determining vulnerabilities in a target application of a mobile device embodied therewith, the program instructions executable by a processor to cause the processor to perform:
analyzing an inter-application communication interface of the target application to construct a list of incoming messages by:
extracting message types of the incoming messages from a manifest file of the target application, and
determining permissions required from a caller application for the message types of the incoming messages by parsing meta-information of the manifest file;
analyzing, by the processor, how the target application responds to the message types of the incoming messages utilizing the list to associate caller permissions with the message types by:
associating the caller permissions with the message types of the incoming messages and sensitive functionality utilizing the list by building safe fix point approximations of sensitive functionalities of the target application on a per-component basis,
wherein the sensitive functionality define operations performed by the target application in response to the message types,
wherein the fix point solution approximations permit a direct comparison between the caller permissions and the incoming message types, and
determining whether a component requires permission to invoke the sensitive functionality; and
determining the vulnerabilities of the target application based on discrepancies between the caller permissions and the message types; and
utilizing the vulnerabilities of the target application as a run-time component to block attacks by a malicious application,
wherein the incoming messages comprise required data that identifies which components of the mobile device to which a particular incoming message is delivered,
wherein analyzing the inter-application communication interface comprises constructing the list of the incoming messages according to the required data,
wherein the meta-information includes application component information that details a required permission table for each one of the components of the mobile device.

10-17. (canceled)

17. A system, comprising a processor and a memory storing program instructions for determining vulnerabilities in a target application of a mobile device thereon, the program instructions executable by a processor to cause the system to perform:
analyzing an inter-application communication interface of the target application to construct a list of incoming messages by:
extracting message types of the incoming messages from a manifest file of the target application, and
determining permissions required from a caller application for the message types of the incoming messages by parsing meta-information of the manifest file;
analyzing, by the processor, how the target application responds to the message types of the incoming messages utilizing the list to associate caller permissions with the message types by:
associating the caller permissions with the message types of the incoming messages and sensitive functionality utilizing the list by building safe fix point approximations of sensitive functionalities of the target application on a per-component basis,
wherein the sensitive functionality define operations performed by the target application in response to the message types,
wherein the fix point solution approximations permit a direct comparison between the caller permissions and the incoming message types, and
determining whether a component requires permission to invoke the sensitive functionality; and
determining the vulnerabilities of the target application based on discrepancies between the caller permissions and the message types; and
utilizing the vulnerabilities of the target application as a run-time component to block attacks by a malicious application,
wherein the incoming messages comprise required data that identifies which components of the mobile device to which a particular incoming message is delivered,
wherein analyzing the inter-application communication interface comprises constructing the list of the incoming messages according to the required data,
wherein the meta-information includes application component information that details a required permission table for each one of the components of the mobile device.

18-20. (canceled)

21. The method of claim 1, wherein the method comprises reporting the vulnerabilities of the target application.

22. The method of claim 1, wherein the method comprises storing the vulnerabilities of the target application as a vulnerability report for later use.

23-24. (canceled)
